(19) United States
(12) Patent Application Publication
(10) Pub. No.: US 2026/0269442 A1
(43) Pub. Date: Sep. 10, 2026

(54) A CONTACTLESS RADIO FREQUENCY ROTARY JOINT AND A METHOD TO ASSEMBLE THE SAME

(71) Applicant: AMPHENOL INTERCONNECT INDIA PVT. LTD., PUNE (IN)

(72) Inventors: APURVA A. CHOUDHARI, Pune (IN); JALILUL REHMAN KHAN, PUNE (IN)

(21) Appl. No.: 19/491,403

(22) PCT Filed: Jan. 11, 2024
(86) PCT No.: PCT/IB2024/050270

§ 371 Date: Dec. 9, 2025

(30) Foreign Application Priority Data
Jun. 19, 2023 (IN) 202321041607
Jan. 11, 2024 (WO) PCT/IB2024/050270

(51) Int. Cl. H01P 1/06

(52) U.S. Cl. CPC H01P 1/062

(57) ABSTRACT

A contactless radio frequency (RF) rotary joint 100 is disclosed. The contactless RF rotary joint includes a circular structure 102 with a hollow central bore 104. The circular structure includes a circular ring 106, a shielding surface 110, and a dielectric medium 112. The circular ring is positioned on a face of the circular structure with an opening 108. The opening is adapted to adjust to a frequency of operation of a RF rotary joint and a reflection loss corelated to width and thickness of the circular ring. The shielding surface is adapted to fit inside the circular ring with a predefined gap from the circular ring. The shielding surface is configured to keep the impedance within a preferred value and acts as a base for stacking of multiple circular structures. The dielectric medium formed in-between the circular ring and adapted to define size of the central bore.

### EARLIEST PRIORITY DATE

This Application claims priority from a provisional patent application filed in India having Patent Application No. 202321041607, filed on Jun. 19, 2023, and titled “A CONTACTLESS ROTARY JOINT AND A METHOD THEREOF” and PCT application filed having Patent Application No. PCT/IB 2024/050270, filed on Jan. 11, 2024, and titled “A CONTACTLESS RADIO FREQUENCY ROTARY JOINT AND A METHOD TO ASSEMBLE THE SAME”.

### FIELD OF INVENTION

Embodiments of a present disclosure relate to radio frequency rotary joints and more particularly to a contactless RF radio frequency rotary joint and a method to assemble the same.

### BACKGROUND

Specific devices are used for conducting electrical signals between two component that are rotatable relative to one another. Such devices generally are known as radio frequency (RF) rotary joints or rotary electrical interfaces. The RF rotary joint is a rotary device that connects a rotating plane to a fixed plane for transfer of RF Power. Further, contactless RF connectors, for instance RF rotary joints sometimes demands to have a centre bore and with multi-RF channel capability.

The currently available solutions limit or compromise on the electrical/RF performance that is insertion loss, return loss, isolation and power handling-which are critical in the applications. The products with the RF rotary joints are used in applications such as military radars, air traffic control, and the like, which demands a high reliability and performance in environmental, mechanical, and electrical performance of a slipring and RF rotary joints. The currently available RF rotary joints has less working life and periodic maintenance. RF rotary joint the high complexities involved in designing, higher number of components of the RF rotary joints and criticality of each individual component dimensions makes them more expensive, sensitive to performance variations over the product life and high in weight.

Hence, there is a need for a contactless radio frequency rotary joint and a method to assemble the same which addresses the aforementioned issues.

### OBJECTIVE OF THE INVENTION

An objective of the present invention is to provide a contactless radio frequency (RF) rotary joint for a long working life to a product without maintenance and smooth rotation of the RF rotary joint.

Another objective of the present invention is to provide a less complex RF rotary joint with lesser number of components and lesser criticality of each individual component dimensions, hence making the RF rotary joint more cost effective, and consistent performance over a long life.

Yet, an objective of the present invention is to provides a hollow centre bore contact-less RF rotary joint, wherein the size of the centre bore is customizable to allow other slip ring parts/media RF rotary joints/fibre optic RF rotary joints etc. to be used under a hybrid solution requirements.

### BRIEF DESCRIPTION

In accordance with one embodiment of the disclosure, a contactless RF rotary joint is provided. The contactless RF rotary joint includes a circular structure. The circular structure with a central bore includes a circular ring, shielding surface, and a dielectric medium. The circular ring is positioned on a face of the circular structure with an opening. The opening is adapted to adjust to a frequency of operation of a RF rotary joint and a reflection loss corelated to width and thickness of the circular ring. The shielding surface is adapted to fit inside the circular ring with a predefined gap from the circular ring. The shielding surface is configured to keep the impedance within a preferred value. The shielding surface acts as a base for stacking of multiple circular structures. The dielectric medium is formed in-between the circular ring. The dielectric medium is adapted to define size of the central bore. The dielectric medium is used to further reduce the overall product dimension, but an ideal option is to use air for the optimum performance.

In accordance with another embodiment a method for assembling a contactless RF rotary joint is provided. The method includes positioning, a circular ring on a face of a circular structures with an opening, wherein the opening is adapted to adjust to a frequency of operation of a RF rotary joint and a reflection loss corelated to width and thickness of the circular ring. The method also includes fitting, a shielding surface inside the circular ring with a predefined gap from the circular ring, wherein the shielding surface is configured to keep the impedance within a preferred value and acts as a base for stacking of multiple circular structures. Further, the method includes forming, a dielectric medium in-between the circular ring, wherein the dielectric medium is adapted to define size of the central bore. The feed to the circular ring needs have a power divider or a direct contact with an external connector/coaxial cable-again depending on the specific requirements on the operating frequency band/s.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a schematic representation of a contactless radio frequency (RF) rotary joint in accordance with an embodiment of the present disclosure;

FIG. 2a is a schematic representation of front view of a product with a stacked circular structure of the contactless RF rotary joint of FIG. 1 in accordance with an embodiment of the present disclosure;

FIG. 2b is a schematic representation of side view of the product with a stacked circular structure of the contactless RF rotary joint of FIG. 1 in accordance with an embodiment of the present disclosure; and

FIG. 3 is a flow chart representing steps involved a method for assembling a contactless RF rotary joint in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures, or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a contactless RF rotary joint is provided. The contactless RF rotary joint includes a circular structure. The circular structure with a central bore includes a circular ring, shielding surface, and a dielectric medium. The circular ring is positioned on a face of the circular structure with an opening. The opening is adapted to adjust to a frequency of operation of a RF rotary joint and a reflection loss corelated to width and thickness of the circular ring. The shielding surface adapted to fit inside the circular ring with a predefined gap from the circular ring. The shielding surface is configured to keep the impedance within a preferred value. The shielding surface acts as a base for stacking of multiple circular structures. The dielectric medium arranged in-between the circular ring, wherein the dielectric medium is adapted to define size of the central bore.

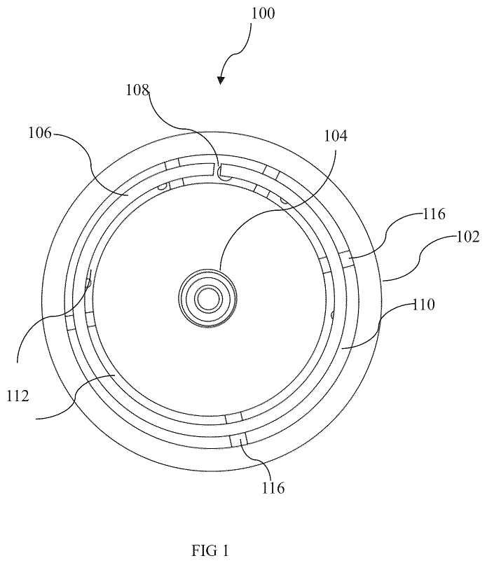

FIG. 1 is a schematic representation of a contactless RF rotary joint in accordance with an embodiment of the present disclosure. The contactless RF rotary joint 100 includes a circular structure 102. The circular structure 102 is with a central bore 104 includes a shielding surface 110 and a dielectric medium 112. In one embodiment, the circular structure 102 comprises a circular groove 114 arranged on a front side of the circular structure 102 to accommodate a circular ring 106. In another embodiment, a gap between the circular ring 106 and the circular groove 114 comprises a plurality of insulators 116. A combination of the plurality of insulators 116 and air trapped in-between two consecutive insulators forms the dielectric medium 112. In one embodiment, the plurality of insulators 116 are fabricated with a Teflon material. In one embodiment, the central bore 104 is adapted to expand for fitting a radio frequency slip ring of multiple sizes.

The circular ring 106 is positioned on a face of the circular structure 102 with an opening 108. The opening 108 is adapted to adjust to a frequency of operation of a RF rotary joint and a reflection loss corelated to width and thickness of the circular ring 106. In one embodiment, the opening 108 enables effective transfer of energy with minimum energy loss.

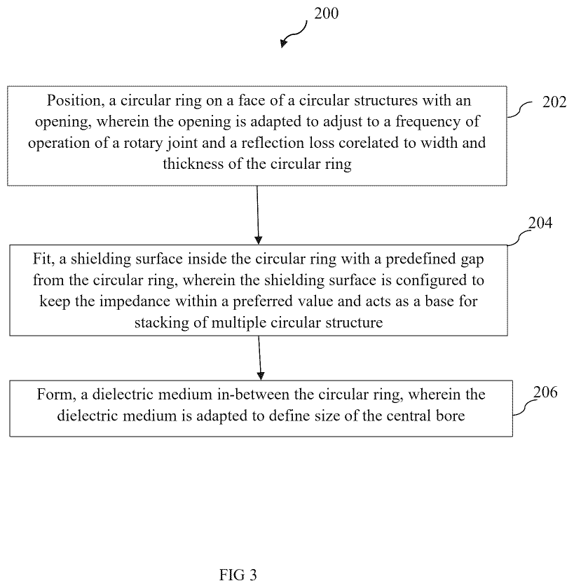

The shielding surface 110 (shown in FIG. 3) is adapted to fit inside the circular ring 106 with a predefined gap from the circular ring 106. The shielding surface 110 is configured to keep the impedance within a preferred value. The shielding surface 110 acts as a base for stacking of multiple circular structures.

The dielectric medium 112 is formed in-between the circular ring 106. The dielectric medium 112 is adapted to define size of the central bore 104. In one embodiment, the dielectric medium 112 in-between the signal ring may define the size of the bore that is required in a hybrid slipring and RF rotary joint design. RF rotaries joint the lowest loss by the air in the dielectric medium 112, provides the highest radio frequency performance and the continuous wave (CW) power transmission is limited only to the input connector or terminating cable (input and output). In one, embodiment, a dielectric material used in the dielectric medium 112 is a poor conductor of electricity but an efficient supporter of electrostatic fields. It can store electrical charges, have a high specific resistance and a negative temperature coefficient of resistance.

A feed line system may be incorporated, to optimize the signal paths to the rings-should a need arises. The plurality of feedlines is positioned equidistantly for absolute transmission of power. In one embodiment, a plurality of points are provided at posterior side of the circular structure 102 to provide a plurality of cables placed equidistantly.

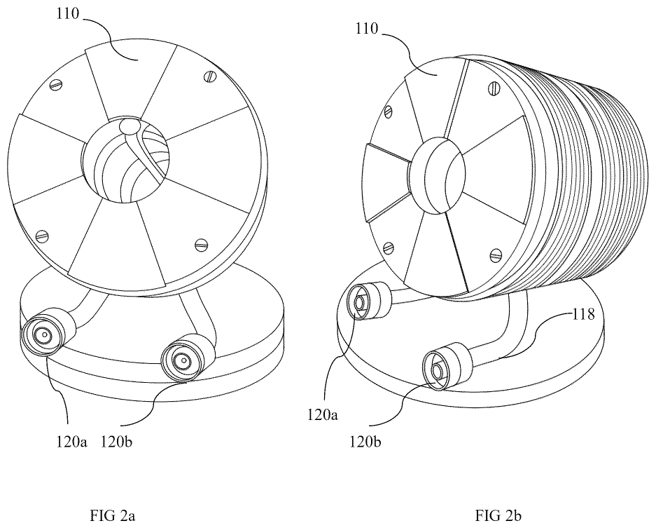

FIG. 2a is a schematic representation of a product with the stacked contactless RF rotary joint of FIG. 1 in accordance with an embodiment of the present disclosure and FIG. 2b is a schematic representation of side view of the product with the stacked contactless RF rotary joint of FIG. 1 in accordance with an embodiment of the present disclosure. In one embodiment, the circular opened ring with, the open path is adjusted to the frequency of operation and the reflection losses tuned to the width and thickness of the rings. The input and output ring dimensions remain same, and a shielding surface 110 is maintained to keep the impedance at 50/75 ohms as required. The product with stacked contactless RF rotary joints includes at least two input cables (120a, 120b) as an input terminal for the electric current. In one embodiment, the circular structure 102 includes a cable 118 connected to a posterior side of the circular structure 102. In one embodiment, the cable 118 transfers energy from one circular ring 106 to another circular ring 106 when stacked on each other. In another embodiment, the cable 118 is connected to a plurality of feedlines to optimize a plurality of signal paths to the circular ring 106.

FIG. 3 is a flow chart representing steps involved a method 200 for assembling a contactless RF rotary joint in accordance with an embodiment of the present disclosure. The method includes positioning, a circular ring on a face of a circular structures with an opening, wherein the opening is adapted to adjust to a frequency of operation of a RF rotary joint and a reflection loss corelated to width and thickness of the circular ring in step 202.

The method 200 also includes fitting, a shielding surface inside the circular ring with a predefined gap from the circular ring, wherein the shielding surface is configured to keep the impedance within a preferred value and acts as a base for stacking of multiple circular structures in step 204. The method also includes expanding, the central bore for fitting a radio frequency slip ring of multiple sizes.

Further, the method 200 forming, a dielectric medium in-between the circular ring, wherein the dielectric medium is adapted to define size of the central bore in step 206. The method also includes forming, the dielectric medium by a combination of a plurality of insulators and air trapped in-between two consecutive insulators forms.

The method 200 also includes providing, a circular groove arranged on a front side of the circular structure to accommodate the circular ring. The method 200 also includes providing, the plurality of insulators in a gap between the circular ring and the circular groove. The method 200 also includes fabricating, the plurality of insulators with a Teflon material. The method 200 also includes providing, a cable attached to a posterior side of the circular structure. In one embodiment, the cable is connected to a plurality of feedlines to optimize a plurality of signal paths to the circular ring, wherein the plurality of feedlines is positioned equidistantly for absolute transmission of power.

Various embodiments of the present disclosure provides a contactless RF rotary joint long working life without maintenance. The contactless RF rotary joint disclosed in the present disclosure have less complex design, lower number of components of the RF rotary joints. Due to a smaller number of components, each individual component dimensions makes the product with the contactless RF rotary joint less expensive, less sensitive to performance variations over the product life and low in weight. The contact less RF rotary joint disclosed in the present disclosure provides a dielectric medium for customizing the bore size.

Further, the present disclosure enable adjustment of frequency of operation of a RF rotary joint and a reflection loss. The contactless RF rotary joint is providing a plurality of insulators adapted to smooth rotation of the RF rotary joint. The present disclosure provides a customizable centre bore of the contact-less RF rotary joint with a narrow band frequency of operation which need not to be maintained for proper performance for a particular frequency bands.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A contactless radio frequency rotary joint comprising:
a circular structure with a central bore, wherein the circular structure comprises:
a circular ring positioned on a face of the circular structure with an opening, wherein the opening is adapted to adjust to a frequency of operation of a radio frequency rotary joint and a reflection loss corelated to width and thickness of the circular ring;
a shielding surface adapted to fit inside the circular ring with a predefined gap from the circular ring,
wherein the shielding surface is configured to keep the impedance within a preferred value; and
wherein the shielding surface acts as a base for stacking of multiple circular structures; and
a dielectric medium formed in-between the circular ring, wherein the dielectric medium is adapted to define size of the central bore.

2. The contactless radio frequency rotary joint as claimed in claim 1, wherein the central bore is adapted to expand for fitting a radio frequency slip ring of multiple sizes.

3. The contactless radio frequency rotary joint as claimed in claim 1, wherein the circular structure comprises a circular groove arranged on a front side of the circular structure to accommodate the circular ring.

4. The contactless radio frequency rotary joint as claimed in claim 3, wherein a gap between the circular ring and the circular groove comprises a plurality of insulators.

5. The contactless radio frequency rotary joint as claimed in claim 3, wherein a combination of the plurality of insulators and air trapped in-between two consecutive insulators forms the dielectric medium.

6. The contactless radio frequency rotary joint as claimed in claim 3, wherein the plurality of insulators are fabricated with a Teflon material.

7. The contactless radio frequency rotary joint as claimed in claim 1, comprises a cable attached to a posterior side of the circular structure.

8. The contactless radio frequency rotary joint as claimed in claim 7, wherein the cable is connected to a plurality of feedlines to optimize a plurality of signal paths to the circular ring, wherein the plurality of feedlines is positioned equidistantly for absolute transmission of power.

9. A method for assembling a contactless radio frequency rotary joint comprising:
positioning, a circular ring on a face of a circular structure with an opening, wherein the opening is adapted to adjust to a frequency of operation of a radio frequency rotary joint and a reflection loss corelated to width and thickness of the circular ring;
fitting, a shielding surface inside the circular ring with a predefined gap from the circular ring, wherein the shielding surface is configured to keep the impedance within a preferred value and acts as a base for stacking of multiple circular structures; and
forming, a dielectric medium in-between the circular ring, wherein the dielectric medium is adapted to define size of the central bore.
